(19) United States
(12) Patent Application Publication
(10) Pub. No.: US 2024/0321297 A1
(43) Pub. Date: Sep. 26, 2024

(54) MAGNETIC HEAD INSPECTION METHOD AND MAGNETIC HEAD INSPECTION DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Masaki HONDA, Yokohama Kanagawa (JP)

(21) Appl. No.: 18/462,322

(22) Filed: Sep. 6, 2023

(30) Foreign Application Priority Data
Mar. 24, 2023 (JP) 2023-047792

(51) Int. Cl. G11B 5/455

(52) U.S. Cl. CPC G11B 5/455

(57) ABSTRACT

According to one embodiment, a magnetic head inspection method includes variably setting, according to a relationship between a characteristic value indicating a characteristic of an inspected magnetic head and a target moving average value of the characteristic value, a threshold of the characteristic value used for inspection in a range of upper and lower limits.

### CROSS-REFERENCE TO RELATED APPLICATIONS

This application is based upon and claims the benefit of priority from Japanese Patent Application No. 2023-047792, filed on Mar. 24, 2023; the entire contents of which are incorporated herein by reference.

### FIELD

Embodiments described herein relate generally to a magnetic head inspection method and a magnetic head inspection device.

### BACKGROUND

Although a fixed threshold is applied to a standard of a test of a magnetic head for which test is performed to secure performance of a magnetic disk device, there is a problem that shipping quality depends on a characteristic caused by a wafer that is a material of the magnetic head.

### BRIEF DESCRIPTION OF THE DRAWINGS

FIG. 1 is a view illustrating an example of a configuration of a magnetic disk device of an embodiment;

FIG. 2 is a view illustrating an example of an inspection method of the embodiment;

FIG. 3 is a view illustrating an example of a relationship between an average value of characteristic values of a plurality of magnetic heads to be inspected and a characteristic value of a magnetic head determined to be a non-defective product according to the embodiment;

FIG. 4 is a view illustrating an example of a hardware configuration of an inspection device of the embodiment;

FIG. 5 is a view illustrating an example of functions of the inspection device of the embodiment;

FIG. 6 is a view illustrating an example of a threshold change of the embodiment; and

FIG. 7 is a flowchart illustrating an example of processing executed by the inspection device of the embodiment.

### DETAILED DESCRIPTION

In general, according to one embodiment, a magnetic head inspection method includes variably setting, according to a relationship between a characteristic value indicating a characteristic of an inspected magnetic head and a target moving average value of the characteristic value, a threshold of the characteristic value used for inspection in a range of upper and lower limits.

Hereinafter, a magnetic head inspection method indicating a method of inspecting a magnetic head of a magnetic disk device, and a magnetic head inspection device that performs the magnetic head inspection method according to one embodiment will be explained in detail with reference to the accompanying drawings. Note that the present invention is not limited by the description of the present embodiment.

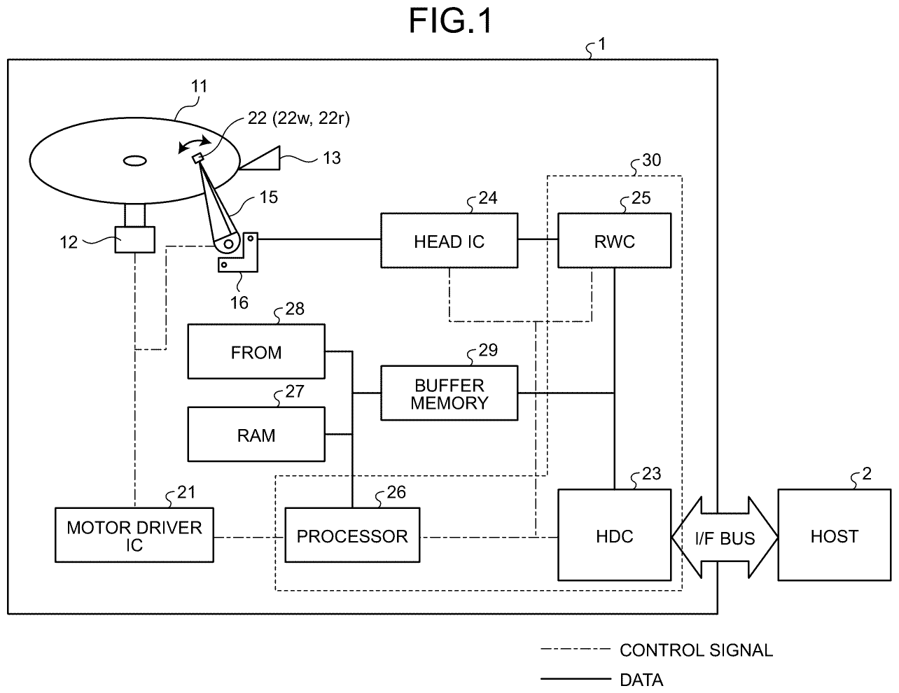

FIG. 1 is a schematic diagram illustrating an example of a configuration of a magnetic disk device 1 including a magnetic head 22 inspected by a magnetic head inspection device of the present embodiment.

The magnetic disk device 1 is connected to a host 2. The magnetic disk device 1 can receive an access command such as a write command or a read command from the host 2.

The magnetic disk device 1 includes a magnetic disk 11 on a surface of which a recording surface is formed. The magnetic disk device 1 writes and reads data to and from the magnetic disk 11 (more specifically, the recording surface of the magnetic disk 11) in response to the access command. Note that although the magnetic disk device 1 may include a plurality of the magnetic disks 11, it is assumed in the embodiment that the magnetic disk device 1 includes one magnetic disk 11 for the sake of simplicity of description and illustration.

Writing and reading of data are performed via a magnetic head 22. Specifically, in addition to the magnetic disk 11, the magnetic disk device 1 includes a spindle motor 12, a motor driver integrated circuit (IC) 21, the magnetic head 22, an actuator arm 15, a voice coil motor (VCM) 16, a ramp 13, a head IC 24, a read/write channel (RWC) 25, a RAM 27, a flash read only memory (FROM) 28, a buffer memory 29, a hard disk controller (HDC) 23, and a processor 26.

The magnetic disk 11 is rotated at a predetermined rotation speed by the spindle motor 12 attached to a rotation shaft of the magnetic disk 11. The spindle motor 12 is driven by the motor driver IC 21.

The motor driver IC 21 controls a rotation of the spindle motor 12 and a rotation of the VCM 16.

The magnetic head 22 to be inspected of the present embodiment writes and reads data to and from the magnetic disk 11 by using a write element 22w and a read element 22r provided therein. The magnetic head 22 is attached to a distal end of the actuator arm 15. The magnetic head 22 is moved in a radial direction of the magnetic disk 11 by the VCM 16 driven by the motor driver IC 21.

For example, when a rotation of the magnetic disk 11 is stopped, the magnetic head 22 is moved onto the ramp 13. The ramp 13 is configured to hold the magnetic head 22 at a position separated from the magnetic disk 11.

At the time of reading, the head IC 24 amplifies and outputs a signal read from the magnetic disk 11 by the magnetic head 22, and supplies the signal to the RWC 25. Furthermore, the head IC 24 amplifies a signal corresponding to data to be written, the data being supplied from the RWC 25, and supplies the amplified signal to the magnetic head 22.

The HDC 23 performs control of transmission and reception of data to and from the host 2 via an I/F bus, control of the buffer memory 29, error correction processing of read data, and the like.

The buffer memory 29 is used as a buffer for data transmitted to and received from the host 2. For example, the buffer memory 29 is used to temporarily store data to be written to the magnetic disk 11 or data read from the magnetic disk 11.

The buffer memory 29 includes, for example, a volatile memory that can perform a high-speed operation. A type of the memory included in the buffer memory 29 is not limited to a specific type. The buffer memory 29 may include, for example, a dynamic random access memory (DRAM), a static random access memory (SRAM), or a combination thereof.

The RWC 25 modulates the data to be written, the data being supplied from the HDC 23, and supplies the modulated data to the head IC 24. In addition, the RWC 25 demodulates the signal read from the magnetic disk 11 and supplied from the head IC 24, and outputs the demodulated signal to the HDC 23 as digital data.

The processor 26 is, for example, a central processing unit (CPU). The RAM 27, the flash read only memory (FROM) 28, and the buffer memory 29 are connected to the processor 26.

The FROM 28 is a nonvolatile memory. The FROM 28 stores firmware (program data), various operation parameters, and the like. Note that the firmware may be stored in the magnetic disk 11.

The RAM 27 includes, for example, a DRAM, an SRAM, or a combination thereof. The RAM 27 is used as an operation memory by the processor 26. The RAM 27 is used as an area in which the firmware is loaded and an area in which various types of management data are held.

The processor 26 performs overall control of the magnetic disk device 1 according to the firmware stored in the FROM 28 or the magnetic disk 11. For example, the processor 26 loads the firmware from the FROM 28 or the magnetic disk 11 to the RAM 27, and executes control of the motor driver IC 21, the head IC 24, the RWC 25, the HDC 23, and the like according to the loaded firmware.

Note that the configuration including the RWC 25, the processor 26, and the HDC 23 can also be regarded as a controller 30. In addition to these elements, the controller 30 may include another element (such as the RAM 27, the FROM 28, the buffer memory 29, the RWC 25, or the like).

In order to secure the performance of the magnetic disk device 1 described above, inspection (operation characteristic test) of the magnetic head 22 is performed before product shipping. The inspection is performed by determination whether a characteristic value indicating a characteristic of the magnetic head 22 is equal to or larger than a threshold, and the magnetic head 22 passes the inspection (that is, as a non-defective product) and is permitted to be shipped in a case where the characteristic value is equal to or larger than the threshold. On the other hand, in a case where the characteristic value is smaller than the threshold, the magnetic head 22 fails the inspection (that is, as an NG product) and is not permitted to be shipped. Although a capacity per head surface of the magnetic head 22 is adopted as an example of the characteristic value in the present embodiment, the characteristic value is not limited thereto.

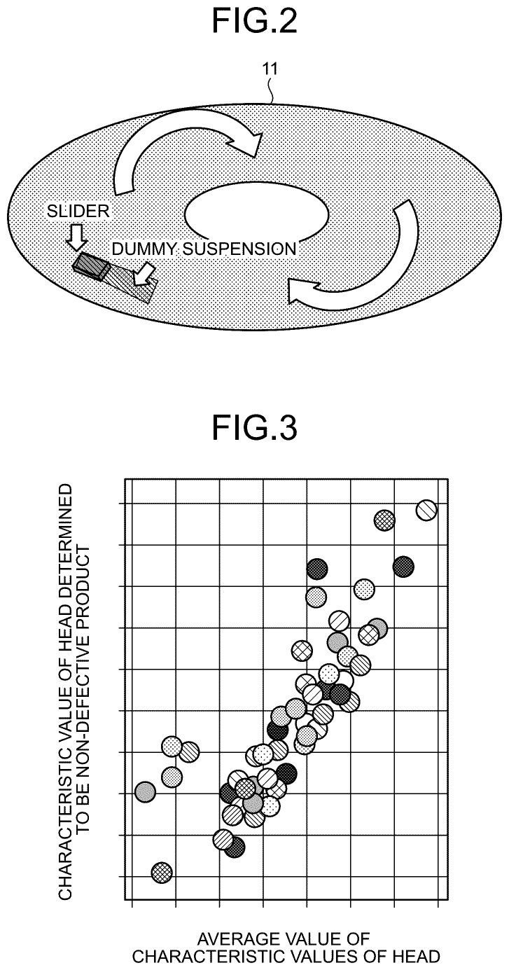

For example, as illustrated in FIG. 2, the magnetic disk 11 is rotated in a state in which a slider piece is mounted on a dummy suspension, and the magnetic head 22 is loaded, whereby the above inspection can be performed. After the inspection, the magnetic head 22 is unloaded, and the magnetic head 22 is removed from the dummy suspension. This series of operations is performed with an automatic device in such a manner that all operations can be performed automatically. The pass/fail of the magnetic head 22 is assigned by a handler to the slider piece that ends the inspection, and the slider piece is set in a slider tray.

FIG. 3 is a view illustrating an example of a relationship between an average value of characteristic values (in this example, the capacity per head surface) of a plurality of the magnetic heads 22 to be inspected and a characteristic value of the magnetic head 22 determined to be a non-defective product. In FIG. 3, circles of the same pattern indicate that the magnetic heads 22 are manufactured from the same wafer. As also understood from FIG. 3, the two are in a substantially proportional relationship, and in a group in which the magnetic heads 22 manufactured from wafers having high characteristic values are continuous, quality of the group is high (in other words, the characteristic values of the magnetic heads 22 that belong to the group are high). On the other hand, in a group in which the magnetic heads 22 manufactured from wafers having low characteristic values are continuous, quality of the group is low (in other words, the characteristic values of the magnetic heads 22 that belong to the group are low). That is, the quality of the magnetic heads 22 to be shipped depends on the characteristics of the wafers of when the magnetic heads 22 are manufactured.

In recent years, importance of the capacity per head surface has increased as a comprehensive index of the magnetic disk device 1. In addition, it becomes also possible to predict the capacity per head surface of the magnetic head 22 alone due to improvement in machine learning technology, and it becomes possible to grasp component quality that has been difficult to grasp from characteristic values such as a core width and an error rate. In view of this point, in the present embodiment, the inspection before shipping is performed with the capacity per head surface of the magnetic head 22 as the characteristic value. However, when the threshold in this inspection is fixed, as described above, the shipping quality of the magnetic head 22 depends on the characteristic of the wafer that is the material of the magnetic head 22.

Thus, one of the objects of the present embodiment is to promote leveling of the shipping quality by dynamically changing the threshold in such a manner as to relax a passing criterion of the group with good quality and strengthen the passing criterion of the group with poor quality in the above-described inspection before product shipment. Hereinafter, a configuration of an inspection device of the present embodiment will be described. The inspection device of the present embodiment is provided separately from the magnetic disk device 1.

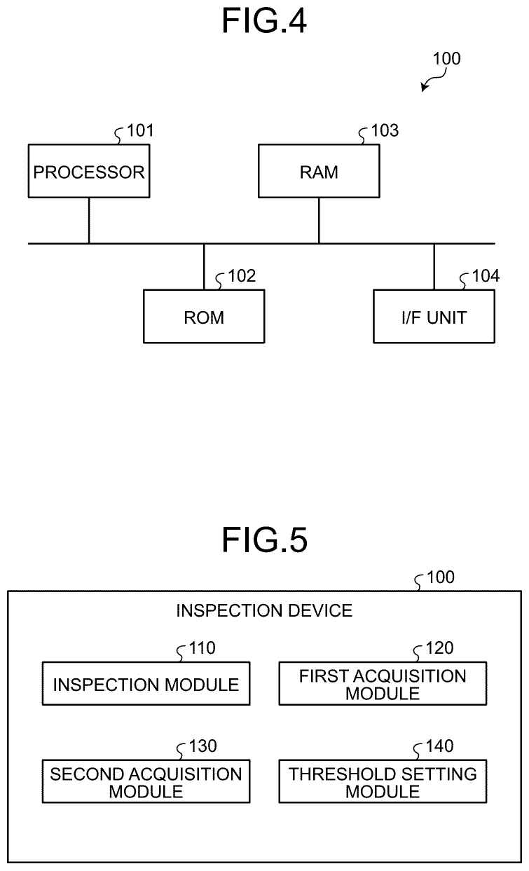

FIG. 4 is a view illustrating an example of a hardware configuration of an inspection device 100 of the present embodiment. As illustrated in FIG. 4, the inspection device 100 includes a processor 101, a ROM 102, a RAM 103, and an I/F unit 104. Note that the hardware elements of the inspection device 100 are not limited to the configuration illustrated in FIG. 4, and may include other hardware elements (such as an operation device, a display device, and the like).

The processor 101 is, for example, a central processing unit (CPU), and integrally controls an operation of the inspection device 100. The processor 101 realizes various functions of the inspection device 100 by executing programs stored in the ROM 102 or the like. Various functions of the inspection device 100 will be described later.

The ROM 102 is a nonvolatile memory, and stores various kinds of data including the programs executed by the processor 101.

The RAM 103 is a volatile memory having a work area of the CPU 101.

The I/F unit 104 is an interface for connection to an external device including the magnetic head 22 to be inspected and the like.

Next, the functions of the inspection device 100 according to the present embodiment will be described.

FIG. 5 is a view illustrating an example of the functions of the inspection device 100 according to the present embodiment. As illustrated in FIG. 5, for example, the inspection device 100 includes an inspection module 110, a first acquisition module 120, a second acquisition module 130, and a threshold setting module 140.

Note that although only the functions necessary for a description of a main part of the present embodiment are illustrated in the example of FIG. 5, the functions of the inspection device 100 are not limited thereto. In addition, some or all of the functions illustrated as the example in FIG. 5 may be realized by a dedicated hardware circuit (such as a semiconductor integrated circuit).

The inspection module 110 inspects the magnetic head 22 to be inspected. More specifically, the inspection module 110 of the present embodiment acquires the capacity per head surface of the magnetic head 22 to be inspected, and determines whether the acquired capacity per head surface is equal to or larger than a threshold. For example, the inspection module 110 can perform a function of rotating the magnetic disk 11 and perform control necessary for inspection, such as loading/unloading of the magnetic head 22.

The first acquisition module 120 acquires a characteristic value indicating a characteristic of the inspected magnetic disk 11.

The second acquisition module 130 acquires a target moving average value of the characteristic value (target moving average value). In the present embodiment, the second acquisition module 130 acquires a target moving average value of a capacity per head surface. For example, the moving average value may be stored in the ROM 102 or the like, or may be stored in a device (such as a server) outside the inspection device 100. The second acquisition module 130 can acquire the moving average value by accessing a memory in which the moving average value is stored. For example, the moving average value can be a different value for each product.

The threshold setting module 140 variably sets the threshold of the characteristic value used for the inspection (in this example, the capacity per head surface) in a range of upper and lower limits according to the relationship between the characteristic value and the moving average value. More specifically, the threshold setting module 140 increases the threshold in a case where the characteristic value is smaller than the moving average value, and decreases the threshold in a case where the characteristic value is equal to or larger than the moving average value.

Note that an increase width and a decrease width of the threshold can be arbitrarily changed according to design conditions and the like. In addition, the range of the upper and lower limits of the threshold can also be arbitrarily set according to the design conditions and the like.

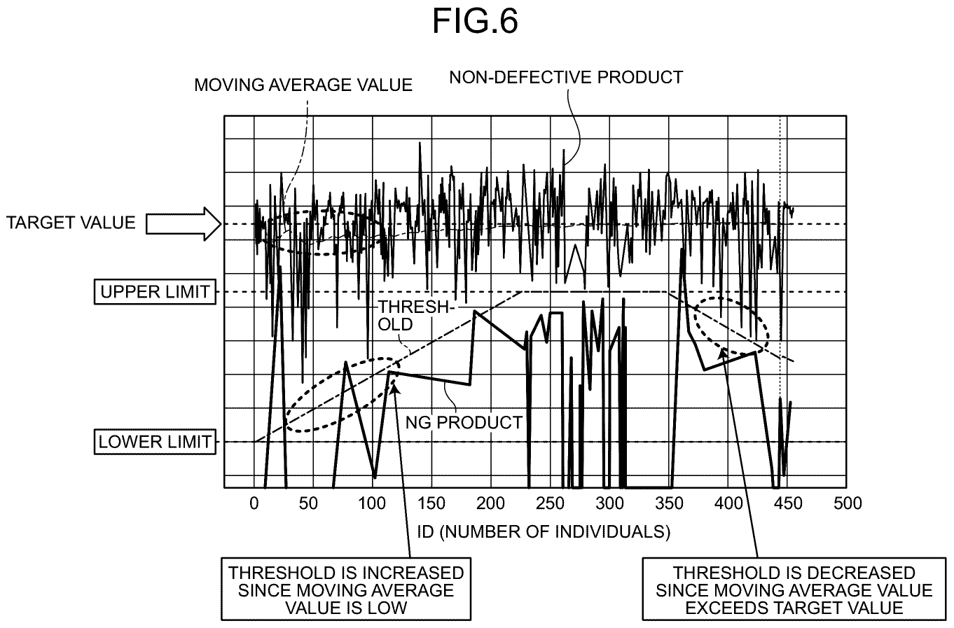

By the operation of the threshold setting module 140, for example, as illustrated in FIG. 6, the threshold increases over time while the characteristic value is smaller than the moving average value, and the threshold decreases over time after the characteristic value becomes equal to or larger than the moving average value. That is, the inspection is automatically strengthened in a case where the characteristic of the magnetic head 22 to be inspected is poor, and the inspection is automatically relaxed in a case where the characteristic is good. As a result, in a group (production lot) having good characteristics on average, a difference from the average value to the worst value of the characteristic values becomes large since the inspection is relaxed. On the other hand, in a group in which the characteristics are poor on average, the difference from the average value to the worst value of the characteristic values becomes small since the inspection is strengthened.

Note that as an example, the target moving average value of the capacity per head surface is set to 108 GB, the upper limit of the threshold is set to 106 GB, the lower limit thereof is set to 100 GB, the increase width of the threshold is set to 0.3 GB, and the decrease width of the threshold is set to −0.3 GB in FIG. 6.

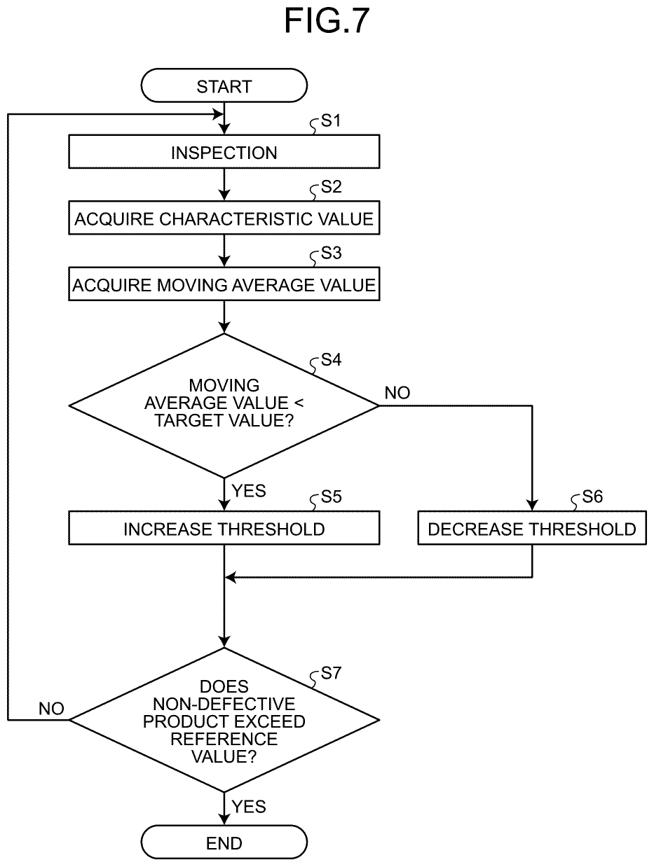

FIG. 7 is a flowchart illustrating an example of processing executed by the inspection device 100 of the present embodiment. Hereinafter, in a description of processing by each of the functions (inspection module 110, first acquisition module 120, second acquisition module 130, threshold setting module 140, and the like) of the inspection device 100, a description of portions overlapping with the above description will be appropriately omitted. Furthermore, order of steps in the flowchart of FIG. 7 is not limited to the example of FIG. 7, and can be changed as appropriate.

As illustrated in FIG. 7, the inspection module 110 inspects the magnetic head 22 to be inspected (S1). As described above, the inspection module 110 acquires the capacity per head surface of the magnetic head 22 to be inspected, determines whether the acquired capacity is equal to or larger than the threshold, and determines whether the magnetic head 22 is a non-defective product or an NG product.

Subsequently, the first acquisition module 120 acquires the above-described characteristic value (S2).

Then, the second acquisition module 130 acquires the above-described moving average value (S3).

Then, the threshold setting module 140 determines whether the characteristic value acquired in S2 is smaller than the moving average value acquired in S3 (S4). In a case where the result of S4 is affirmative (S4: Yes), the threshold setting module 140 increases the threshold (S5). On the other hand, in a case where the result of S4 is negative (S4: No), the threshold setting module 140 decreases the threshold (S6).

After S5 or S6, the inspection device 100 determines whether the non-defective product exceeds a reference value (S7). The reference value can be arbitrarily changed according to the design conditions and the like, and can be set to “400” herein as an example. The processing is ended in a case where the result of S7 is affirmative (S7: Yes), and the processing in and after S1 described above is repeated in a case where the result of S7 is negative (S7: No).

As described above, the inspection method by the inspection device 100 of the present embodiment variably sets the threshold of the characteristic value used for the inspection in the range of the upper and lower limits according to the relationship between the characteristic value indicating the characteristic of the inspected magnetic head 22 (such as the capacity per head surface) and the target moving average value of the characteristic value. More specifically, the threshold is increased in a case where the characteristic value is smaller than the moving average value, and the threshold is decreased in a case where the characteristic value is equal to or larger than the moving average value. That is, the inspection is automatically strengthened in a case where the characteristic of the magnetic head 22 to be inspected is poor, and the inspection is automatically relaxed in a case where the characteristic is good, whereby the characteristic values of the magnetic heads 22 to be shipped can be equalized on average. Thus, it is possible to promote leveling of shipping quality of the magnetic heads 22 (the shipping quality can also be regarded to correspond to the shipping quality of the magnetic disk device 1).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Furthermore, the effects of the embodiment described in the present specification are merely examples and are not limitations, and there may be another effect.

What is claimed is:

1. A magnetic head inspection method indicating a method of inspecting a magnetic head of a magnetic disk device, the inspection method comprising:
variably setting, according to a relationship between a characteristic value indicating a characteristic of the inspected magnetic head and a target moving average value of the characteristic value, a threshold of the characteristic value used for inspection in a range of upper and lower limits.

2. The magnetic head inspection method according to claim 1, further comprising:
increasing the threshold when the characteristic value is smaller than the moving average value, and decreasing the threshold when the characteristic value is equal to or larger than the moving average value.

3. The magnetic head inspection method according to claim 1, wherein
the characteristic value is a capacity per head surface of the magnetic head.

4. The magnetic head inspection method according to claim 2, wherein
the characteristic value is a capacity per head surface of the magnetic head.

5. The magnetic head inspection method according to claim 1, wherein
the magnetic head having the characteristic value equal to or larger than the threshold is determined to pass the inspection.

6. A magnetic head inspection device indicating a device that inspects a magnetic head of a magnetic disk device, the inspection device comprising:
a memory; and
a processor coupled to the memory and configured to:
acquire a characteristic value indicating a characteristic of the inspected magnetic head;
acquire a target moving average value of the characteristic value; and
variably set a threshold of the characteristic value used for inspection in a range of upper and lower limits according to a relationship between the characteristic value and the moving average value.

7. The magnetic head inspection device according to claim 6, wherein
the processor is configured to increase the threshold when the characteristic value is smaller than the moving average value, and decrease the threshold when the characteristic value is equal to or larger than the moving average value.

8. The magnetic head inspection device according to claim 6, wherein
the characteristic value is a capacity per head surface of the magnetic head.

9. The magnetic head inspection device according to claim 7, wherein
the characteristic value is a capacity per head surface of the magnetic head.

10. The magnetic head inspection device according to claim 6, wherein
the processor is further configured to determine that the magnetic head having the characteristic value equal to or larger than the threshold passes the inspection.
